(19) United States
(12) Patent Application Publication
(10) Pub. No.: US 2022/0252730 A1
(43) Pub. Date: Aug. 11, 2022

(54) TIME-OF-FLIGHT IMAGING APPARATUS AND TIME-OF-FLIGHT IMAGING METHOD

(71) Applicant: Sony Semiconductor Solutions Corporation, Kanagawa (JP)

(72) Inventor: Daniel Van Nieuwenhove, Hofstade (BE)

(73) Assignee: Sony Semiconductor Solutions Corporation, Kanagawa (JP)

(21) Appl. No.: 17/621,895

(22) PCT Filed: Jul. 3, 2020
(86) PCT No.: PCT/EP2020/068842

§ 371 Date: Dec. 22, 2021

(30) Foreign Application Priority Data
Jul. 5, 2019 (EP) 19184668.2

(51) Int. Cl. G01S 17/894; G01B 11/22; G01S 7/4865; G01S 7/484

(52) U.S. Cl. CPC G01S 17/894; G01S 7/484; G01S 7/4865; G01B 11/22

(57) ABSTRACT

The present disclosure generally pertains to a time-of-flight imaging apparatus having cir-cuitry, configured to: acquire, in a coarse imaging mode, coarse depth data; acquire, in a precise imaging mode, precise depth data; and determine a distance to a scene based on the coarse depth data and the precise depth data.

### TECHNICAL FIELD

The present disclosure generally pertains to a time-of-flight imaging apparatus and a time-of-flight imaging method.

### TECHNICAL BACKGROUND

Generally, time-of-flight (ToF) devices are known, for example for imaging or creating depth maps of a scene, such as an object, a person, or the like, or to measure a distance, in general. It can be distinguished between direct ToF (dToF) and indirect ToF (iToF) for measuring a distance either by measuring the run-time of emitted and reflected light (dToF) or by measuring one or more phase-shifts of emitted and reflected light (iToF).

In iToF, a quality of a distance measurement can be determined by determining a confidence. For determining the confidence, a read-out indicating the one or more phase shifts is processed and compared with a reference value.

In order to determine the phase-shifts for the confidence determination, ToF image sensors (or pixels) are typically modulated with a lower modulation frequency than a modulation frequency used for a distance determination.

Although there exist techniques for providing time-of-flight images, it is generally desirable to provide a time-of-flight imaging apparatus and a time-of-flight imaging method.

### SUMMARY

According to a first aspect, the disclosure provides a time-of-flight imaging apparatus comprising circuitry, configured to: acquire, in a coarse imaging mode, coarse depth data; acquire, in a precise imaging mode, precise depth data; and determine a distance to a scene based on the coarse depth data and the precise depth data.

According to a second aspect, the disclosure provides a time-of-flight imaging method, comprising: acquiring, in a coarse imaging mode, coarse depth data; acquiring, in a precise imaging mode, precise depth data; and determining a distance to a scene based on the coarse depth data and the precise depth data.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts an embodiment of a timing diagram of a signaling for a determination of a distance;

FIG. 2 depicts a further embodiment of a timing diagram of a signaling for determining a distance to a scene;

FIG. 3 depicts an imaging mode sequence in a block diagram;

FIG. 4 depicts a block diagram of a method according to the present disclosure;

FIG. 5 depicts a block diagram of a further method according to the present disclosure;

FIG. 6 depicts a block diagram of a further method according to the present disclosure;

FIG. 7 depicts a block diagram of a further method according to the present disclosure;

FIG. 8 depicts a block diagram of a further method according to the present disclosure;

FIG. 9 depicts a block diagram of a further method according to the present disclosure;

FIG. 10 depicts a block diagram of a further method according to the present disclosure;

FIG. 11 illustrates an embodiment of a ToF imaging apparatus according to the present disclosure; and

FIG. 12 illustrates a further embodiment of the ToF imaging apparatus.

### DETAILED DESCRIPTION OF EMBODIMENTS

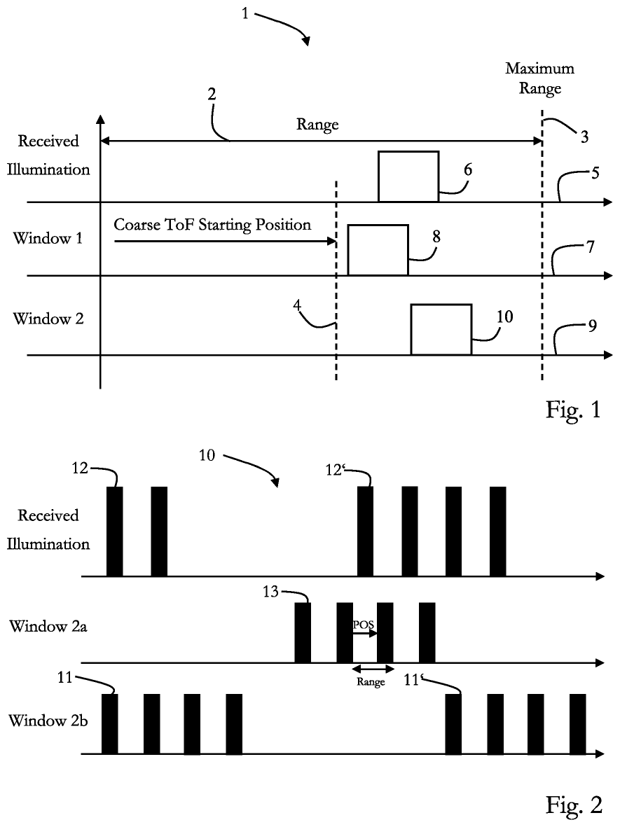

Before a detailed description of the embodiments under reference of FIG. 1 is given, general explanations are made.

As mentioned in the outset, techniques for generating a ToF image are generally known.

However, current ToF measurements are cost-intensive, e.g. due to a high energy consumption using a high modulation frequency for modulating an image sensor, and thereby generating a depth image or performing a distance measurement.

Therefore, a ToF measurement may also be power-consumptive.

Moreover, due to the high modulation frequency, which is correlated with a short pulse length (i.e. a duration in which a light pulse is sent) of a light source of known ToF imaging apparatuses, a measurement range may be limited (e.g. to several centimeters).

Hence, in order to image on a larger range and create a full depth image, multiple distance measurements may need to be performed. For example, a pulse length of one nanosecond may cover a range of fifteen centimeters, since the light may cover thirty centimeters, but, in order to be detected, needs to travel to the scene and back.

It has been recognized that settings for acquiring a confidence, e.g. a lower modulation frequency, may also be utilized for a distance determination.

A distance, which is determined based on the setting for acquiring a confidence, may, therefore, save costs and/or energy consumption, and may have a higher measurement range.

Therefore, some embodiments pertain to a time-of-flight imaging apparatus comprising circuitry, configured to: acquire, in a coarse imaging mode, coarse depth data; acquire, in a precise imaging mode, precise depth data; and determine a distance to a scene based on the coarse depth data and the precise depth data.

The time-of-flight (ToF) imaging apparatus may be any apparatus suitable for imaging or processing a ToF signal, such as a camera, an image sensor, a processor, an FPGA (field-programmable gate array), or the like. The imaging apparatus may be based on known technologies for light detection and it may include pixels or photosensitive elements, which may be arranged in an array, or the like, and which may be based on known technologies, such as CMOS (complementary metal-oxide semiconductor), CCD (charge coupled device), SPAD (single photon avalanche diode), CAPD (current assisted photonic demodulator), etc.

Hence, the circuitry may be one of or a combination of any of the technologies mentioned above, which are connected in a way, such that a ToF signal representing light reflected from a scene (e.g. an object), may be reconstructed into an (ToF) image, such as a depth map, (active or passive) infrared image, or the like.

The ToF signal may be a light signal, which may due to a detection generate an electric signal, or it may be the generated electric signal, and the like.

In general, the ToF signal may be any signal, from which coarse depth data and/or precise depth data may be acquired.

An imaging mode (i.e. the coarse or the precise imaging mode) refers, in some embodiments, to a way of sensing and/or processing imaging information, such as an applying of a modulation signal to a pixel (or parts of a pixel) in order to read out charge stored in the pixel, such that an image may be reconstructed.

The modulation signal may include a predetermined modulation frequency, which may be different for different imaging modes.

For example, in the coarse imaging mode, the predetermined modulation frequency may be lower than a predetermined modulation frequency of the precise imaging mode, or vice versa.

However, in some embodiments, the predetermined modulation frequencies of the coarse imaging mode and the precise imaging mode may be the same, but, in order to distinguish the signals, a read-out may be, for example, stored on different memory nodes, and/or a signal shape (e.g. rectangular, saw tooth, and the like) may be different in the two imaging modes.

The acquisition of the coarse depth data or the precise depth data may, as discussed, be based on a modulation signal with a predetermined frequency, which is applied to (at least one) transfer gate included in or coupled to a pixel in order to read out the electric charge stored in the pixel.

The modulation signal may also be applied to a plurality (e.g. a group, mosaic, or the like) of pixels of a ToF image sensor, which may be grouped by one or more common (shared) transfer gates or circuitry in general, and the like.

Coarse depth data may refer to any type of data (structure), which is generated in the coarse imaging mode in response to the above described acquisition, wherein the coarse depth data may be representative of imaging data having a lower distance accuracy than the precise depth data which may be representative of imaging data having a higher distance accuracy than the coarse depth data.

The coarse depth data may be indicative of a quality of a ToF acquisition or of an imaging process. Moreover, the coarse depth data may be indicative for a rough (coarse) distance between the ToF imaging apparatus and a scene (e.g. an object).

The precise depth data may refer to any type of data (structure), which is generated in the precise imaging mode in response to the above described acquisition.

The precise depth data may be indicative of a distance between the ToF device and the scene, wherein the distance is determined with a higher precision than in the coarse imaging mode. Thus, the name precise imaging mode. It should be noted that the word “precise” should not be construed as an exact determination of the distance. It refers, however, to a more exact determination of the distance than the determination of the distance in the coarse imaging mode, wherein the more exact determination may be indicated with a smaller measurement error (e.g. standard deviation) or a closer distance compared to another method of determining the distance (e.g. a with a measuring tape) than in the coarse imaging mode.

As discussed, distance information may be extracted from the coarse depth data and/or the precise depth data.

In some embodiments, the distance to the scene is based only on the coarse depth data and in other embodiments, the distance to the scene is based only on the precise depth data. Moreover, in some embodiments, the distance to the scene is based on the coarse depth data and the precise depth data.

For example, a coarse distance may be determined and a precise distance may be determined, and a mean value between the coarse distance and the precise distance is evaluated.

Moreover, in some embodiments, coarse depth data is acquired multiple times and a mean value is evaluated, wherein no precise depth data is acquired. Furthermore, precise depth data may be acquired multiple times and no coarse depth data is acquired and a mean value is evaluated from the distance determined out of the precise depth data. Also, a combination of multiple acquisitions of coarse depth data and precise depth data may be envisaged, which may be different in number and performed in an arbitrary sequence.

It should be noted that the present disclosure is not limited to finding a mean value. Any algorithm may be applied in order to determine the distance to the scene.

For example, the coarse imaging mode may be applied and a coarse distance information may be determined based on the coarse depth data, such that a starting position for the precise imaging mode may be determined.

This may be applied, if the scene (or object) exceeds the measurement range, since, as discussed herein, it may not be possible to distinguish between whole number multiples of a distance (e.g. a distance of fifteen centimeters and thirty centimeters may not be distinguished between) due to the modulation frequency of the precise imaging mode.

Hence, if the coarse distance information indicates a distance of thirty centimeters, a starting position of the precise imaging mode may be a predetermined value below thirty centimeters, but above fifteen centimeters. The values given herein, are only for illustrational purposes. Any distance apart from thirty and fifteen centimeters may be determined.

This may be achieved with a corresponding delay for the precise imaging mode, which is set, for example, with a master clock.

The delay (and therewith the starting position) may be updated depending on a situation, e.g. low motion or fast motion of the ToF imaging apparatus.

Moreover, in some embodiments, a signal-to-noise ratio (SNR) of the precise imaging mode may be decreased in a ToF imaging apparatus, which uses phase information by determining the starting position, as discussed above. The SNR may further be increased by choosing (or predetermining, e.g. by a calibration) phase locations, which minimize the SNR. For example, phase locations of 45, 135, 225 and 315 degrees may further minimize the SNR, without limiting the present disclosure in that regard.

In some embodiments, at least one of the ToF imaging apparatus or the scene may move. In such cases, the coarse depth information may be deteriorated.

Hence, in such embodiments, the precise imaging mode may be conducted with an increased measurement range (i.e. lower modulation frequency and/or longer pulse length).

Moreover, the coarse imaging mode may be performed multiple times and a motion estimation algorithm may be applied, such that a best starting position may be extrapolated.

These two measures (increased measurement range and multiple times performing the coarse imaging mode) may also be combined.

In some embodiments, in which the distance determined in the precise imaging mode has a low quality (i.e. the determined distance and the real distance differ more than a predetermined value, or a determined confidence may exceed a predetermined value), the distance determination may be repeated in the precise imaging mode and/or the distance may be determined based on the coarse depth data.

In some embodiments, the circuitry is further configured to provide an imaging mode sequence including the coarse imaging mode and the precise imaging mode.

By providing the imaging mode sequence, a train of coarse depth data and/or of precise depth data may be acquired, such that a measurement error (e.g. standard deviation) may be minimized and/or a quality (e.g. confidence) may be maximized.

For example, the coarse imaging mode and the precise imaging mode may be alternated (e.g. CPCPCPCPCP, wherein C is a frame in the coarse imaging mode and P is a frame in the precise imaging mode). Furthermore, an imaging mode sequence of CCCCPCCCCPCCCCP may be utilized, or PPPCPPPPCPPPPC.

In some embodiments, it may be switched between different imaging mode sequences.

For example, an imaging mode sequence, which includes more P frames than C frames may use more power of a power source than vice versa, but may have a higher precision in determining the distance.

On the other hand, an imaging mode sequence, which includes more C frames than P frames may use less power than vice versa, but may also have a lower precision in determining the distance. Therefore, the switching may depend on an available power and/or a strength of a power supply.

For example, if a ToF imaging apparatus according to the present disclosure is run with a battery, an imaging mode sequence having more P frames than C frames may be applied as long as the battery has enough charge and it may be switched to an imaging mode having more C frames than P frames, when the charge is below a predetermined value.

In embodiments, in which the imaging mode sequence has more C frames than P frames, an average of a determined distance based on the coarse depth data may be determined in order to determine a starting position for the precise imaging mode in the P frame.

The imaging mode sequence may be a sequence of the coarse imaging mode and the precise imaging mode, as discussed above. It may be random or pseudo random sequence, i.e. a number of times the coarse imaging mode is performed may be randomly set and a number of times the precise imaging mode is performed may be randomly set.

However, a number of times of one imaging mode may be predetermined and the number of times the other imaging mode is performed may be random.

Also, determination of which imaging mode may follow on a current imaging mode may be based on randomness. For example, if the coarse imaging mode is performed, it may be decided on a random generator, whether the coarse imaging mode or the precise imaging mode follows.

In some embodiments, the imaging mode sequence may be predetermined, i.e. at least one of the length of the imaging mode sequence or the particular sequence of the imaging modes may be predetermined in number, progression, and the like.

In general, the imaging mode sequence may be provided in the ToF imaging apparatus or acquired from a memory, processor, and the like, coupled to or included in the ToF imaging apparatus.

In some embodiments, the ToF imaging apparatus further includes an image sensor including at least one transfer gate, the circuitry being further configured to modulate, with a modulation signal, the at least one transfer gate for acquiring at least one of the coarse depth data and the precise depth data.

As discussed, the image sensor may be any sensor suitable for performing ToF imaging, and it may be based on known technologies, such as CMOS, CCD, SPAD, CAPD, and the like, which may be arranged in an array, or which may be single elements, e.g. pixels.

The transfer gate may be a gate of a transfer transistor included in the ToF image sensor, which is able to provide a signal indicating a stored charge (e.g. in a floating diffusion element of the ToF image sensor) by applying the modulation signal.

Hence, the modulation signal may be an electric signal configured to trigger the at least one transfer gate for acquiring the coarse depth data and/or the precise depth data.

In some embodiments the modulation signal includes, in the coarse imaging mode, a coarse modulation signal having a coarse modulation frequency and, in the precise imaging mode, a precise modulation signal having a precise modulation frequency, wherein the coarse modulation frequency and the precise modulation frequency differ from each other.

The coarse modulation signal and the precise modulation signal may refer to the modulation signal, which is applied in the coarse imaging mode and the precise imaging mode, respectively. Hence, the modulation signal may not be of a “coarse” or a “precise” nature, but the wording is applied for distinguishing between the two imaging mode.

Moreover, the coarse modulation frequency and the precise modulation frequency may refer to a respective frequency, which is applied in the coarse imaging mode and the precise imaging mode. Thus, the modulation frequency may also not be of a “coarse” or a “precise” nature, and the wording is applied for distinguishing between the two modulation frequencies.

As discussed, the coarse modulation frequency and the precise modulation frequency may differ from each other, i.e. the coarse modulation frequency may be lower or higher than the precise modulation frequency.

The (coarse or precise) modulation frequency may be (pre-)determined and indicated by a periodic repetition of the (coarse or precise) modulation signal applied to e.g. the at least one transfer gate, as it is generally known.

In some embodiments, the modulation signal includes a superposed modulation signal based on a superposing of the coarse modulation frequency and the precise modulation frequency, thereby superposing the coarse imaging mode and the precise imaging mode.

As it is generally known, an electric (or electromagnetic) signal may include multiple frequency components, and to such signals it may be referred to as superposed signals. Moreover, ways are known for superposing different signals (i.e. how to include multiple frequency components into one signal).

Hence, in some embodiments, the superposed modulation signal may include a frequency component of the coarse imaging mode and a frequency component of the precise imaging mode.

Thereby, the coarse imaging mode and the precise imaging mode may be superposed, such that, in some embodiments, coarse depth data and precise depth data may be acquired roughly at the same time instead of in a sequence of the coarse imaging mode and the precise imaging mode.

In some embodiments, the time-of-flight imaging apparatus further includes a pulsed light source configured to emit modulated light for illuminating the scene, the circuitry being further configured to: control the pulsed light source to provide a coarse pulse length in the coarse imaging mode; and control the pulsed light source to provide a precise pulse length in the precise imaging mode, wherein the precise pulse length differs from the coarse pulse length.

The pulsed light source may be any light source configured to emit modulated light (light pulse) in a periodic manner, such that an emission of light may be followed by another emission of light. To each emission, it may be referred to as a pulse, since, typically, the emission of light happens on a short time scale (e.g. nanoseconds to milliseconds).

The pulsed light source may be based on LED (light emitting diode) technology, such as an LED laser, a diode laser, and the like and/or it may be based on a technology utilizing a radiation of low-temperature plasma, a condensed spark discharge in a gas, an exploding wire method, the pinch effect, an excitation of phosphor, e.g. by a passage of an electric current and/or an irradiation by an electron beam, and the like.

The modulated light emitted by the modulated light source may also be generated based on direct modulation, external modulation, or the like. The light may be modulated in amplitude, phase, polarization, and the like, by respective modulators, and the like.

The (modulated) pulsed light source may emit modulated light for illuminating the scene, i.e. a light pulse (or a plurality of light pulses) may be emitted by the pulsed light source, which may be reflected by the scene (or object).

The circuitry may be configured to control the pulsed light source to provide a coarse pulse length in the coarse imaging mode and control the pulsed light source to provide a precise pulse length in the precise imaging mode.

As discussed, for example, for the coarse imaging mode and the precise imaging mode, the coarse pulse length and the precise pulse length may not be of a “coarse” or “precise” nature, but correspond to a respective pulse length of the emitted modulated light in the coarse or precise imaging mode.

The pulse length may refer to a respective (length of) time in which a light pulse is emitted (e.g. 200 nanoseconds, 10 microseconds etc.)

Hence, in the coarse imaging mode, there may be provided a coarse pulse length and in the precise imaging mode there may be provided a precise pulse length.

However, the coarse pulse length and the precise pulse length may differ, since they may be utilized in the coarse imaging mode or in the precise imaging mode, respectively, which may also differ in their properties, such as the respective modulation frequency, as discussed herein.

In some embodiments, the circuitry is further configured to acquire, in the coarse imaging mode, active infrared data.

In some embodiments, the ToF imaging apparatus may be configured to sense infrared light. The sensed infrared light may be distinguished in active and passive infrared light, wherein active infrared light may refer to a reflection of modulated infrared light emitted by the ToF imaging apparatus (e.g. by a modulated infrared light source), without a reconstruction of a distance/depth image.

Passive infrared light may refer to an acquisition of infrared light without a preceding emission of infrared light, i.e. environmental infrared light, e.g. for acquiring background noise, creating a temperature distribution of an environment, and the like.

Hence, in response to acquiring active infrared light, a two-dimensional infrared image may be generated, which may, for example, be used for object recognition, e.g. with a computer vision algorithm, a neural network, and the like.

In some embodiments, the circuitry is further configured to select between one of the coarse imaging mode and the precise imaging mode.

The selection may be based on external or internal conditions, such as temperature, user requirements, the scene (for example, if the scene is far away and only a rough estimation is necessary), velocity (e.g. if the ToF imaging apparatus is used in a vehicle), and the like.

It may further be based on a preceding imaging mode. For example, it may be sufficient to select the coarse imaging mode after the precise imaging mode, and the like, as already discussed above.

Moreover, the selection may be based on a power requirement. In some embodiments, the coarse imaging mode may not use as much (electrical) power as the precise imaging mode, and if the ToF imaging apparatus is electrically supplied with a battery, the coarse imaging mode may be selected at a low battery charge, whereas the precise imaging mode may be selected at a high battery charge.

In particular, the selection may be based on a power requirement of an imaging sensor or a power requirement of a light source, such as a modulated light source, as discussed herein. In general, the imaging sensor and the modulated light source may be supplied with different power sources.

Therefore, the selection may be based under consideration of a power requirement of only the imaging sensor or only the light source, or both.

In some embodiments, the acquisition of coarse depth data in the coarse imaging mode, due to a low modulation frequency which maximizes modulation contrast, reduces power consumption of an image sensor compared to the acquisition of precise depth data in the precise imaging mode.

Moreover, due to the higher modulation contrast, less light intensity may be needed compared to the precise imaging mode. Thus, power of a light source may be saved.

The selection may further be based on an intensity requirement of the light source. For example, if a high light intensity is required (e.g. due to strong environmental light), the light source may not be configured to provide the required high light intensity with a short pulse length in the precise imaging mode. Therefore, the coarse imaging mode may be selected. On the other hand, if environmental light is weak, the intensity requirement may not be high, and therefore, the precise imaging mode may be selected.

The selection may further be based on a contrast requirement, in particular a modulation contrast, which may be maximized, for example, at the coarse modulation frequency, and therefore, the coarse imaging mode may be selected. However, in other embodiments, the modulation contrast may be maximized at the precise modulation frequency, and thus the precise imaging mode may be selected.

The selection may further be based on an aliasing distance. Generally, aliasing is known in imaging, for example, if a sampling frequency (e.g. a modulation frequency) is too low compared to a signal (e.g. based on the Nyquist-Shannon theorem). The signal may be based on reflected light, and the like, and therefore, the distance to the scene may be limited by the modulation frequency. Therefore, distances below or equal to a predetermined threshold may be detected in the precise imaging mode, if the precise imaging frequency is higher than the coarse imaging frequency, whereas it may be sufficient to acquire coarse depth data in the coarse imaging mode for a distance above or equal to the predetermined threshold.

The selection may further be based on a measurement range. Independent of the aliasing distance, and as already discussed herein, the distance to an object above a predetermined threshold may be determined in the coarse imaging mode, and the distance to an object below or equal to the predetermined threshold may be determined in the precise imaging mode, or vice versa.

The selection may further be based on a motion of the ToF imaging apparatus. For example, in embodiments, in which the ToF imaging apparatus is included in a vehicle, the selection may be based, for example, on a velocity of the vehicle. For example, for velocities below a predetermined threshold, the coarse imaging mode may be selected, and above or equal to the predetermined threshold, the precise imaging mode may be selected, or vice versa.

The selection may further be based on the preceding imaging mode, as already discussed herein.

Some embodiments pertain to a time-of-flight imaging method, including: acquiring, in a coarse imaging mode, coarse depth data; acquiring, in a precise imaging mode, precise depth data; and determining a distance to a scene based on the coarse depth data and the precise depth data.

The method may be performed with a ToF imaging apparatus according to the present disclosure, on a computer, server, and the like.

In some embodiments, the ToF imaging method further includes: providing an imaging mode sequence including the coarse imaging mode and the precise imaging mode, as discussed herein. In some embodiments, the imaging mode sequence is at least one of a random sequence and a predetermined sequence, as discussed herein. In some embodiments, the ToF imaging method includes: modulating, with a modulation signal, at least one transfer gate of an image sensor for acquiring at least one of the coarse depth data and the precise depth data, as discussed herein. In some embodiments, the modulation signal includes, in the coarse imaging mode, a coarse modulation signal having a coarse modulation frequency and, in the precise imaging mode, a precise modulation signal having a precise modulation frequency, wherein the coarse modulation frequency and the precise modulation frequency differ from each other, as discussed herein. In some embodiments, the modulation signal includes a superposed modulation signal based on a superposing of the coarse modulation frequency and the precise modulation frequency, thereby superposing the coarse imaging mode and the precise imaging mode, as discussed herein. In some embodiments, the method further includes emitting modulated light for illuminating a scene with a pulsed light source; controlling the pulsed light source to provide a coarse pulse length in the coarse imaging mode; controlling the pulsed light source to provide a precise pulse length in the precise imaging mode, wherein the precise pulse length differs from the coarse pulse length, as discussed herein. In some embodiments, the ToF imaging method further includes, acquiring, in the coarse imaging mode, active infrared data, as discussed herein. In some embodiments, the method further includes: selecting between one of the coarse imaging mode and the precise imaging mode. In some embodiments, the selection is based on at least one of a power requirement of an imaging sensor, a power requirement of a light source, an intensity requirement of the light source, a contrast requirement, an aliasing distance, a measurement range, a motion of a time-of-flight imaging apparatus, and a preceding imaging mode, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is depicted a schematic timing diagram 1 of a signaling for a determination of a distance according to the present disclosure. The acquisition is limited to a measurement range 2, which is limited due to a pulse length or a modulation frequency, as discussed herein. For example, if the pulse length is one nanosecond, light may be able to cover roughly 30 centimeters. However, since reflected light is measured, a maximum range 3 is, in this embodiment, 15 centimeters.

Moreover, a starting position 4 for the acquisition of precise depth data is depicted, which is based on a rough estimation of the distance in a preceding coarse imaging mode.

Furthermore, a scale 5 representing a received illumination includes a reflected light pulse 6.

A scale 7 represents a first measurement window (window 1, also referred to as frame) including a first modulation pulse 8 in the precise imaging mode. During the first measurement window incoming light which was emitted and reflected from a scene can be detected.

A scale 9 represents a second measurement window (window 2, or second frame) including a second modulation pulse 10 in the precise imaging mode. During the second measurement window incoming light which was emitted and reflected from a scene can be detected, wherein the second measurement window is consecutive to the first measurement window in this embodiment and the first and second measurement window do not overlap.

The signals, which are read out in the first and the second measurement window are indicative of a phase shift, from which the distance to the scene can be determined for each imaging mode.

However, a more exact result is achieved with the following formula, which is valid within the measurement range below 15 centimeters (i.e. less than one pulse length) and wherein no ambient light is assumed, since ambient light may deteriorate the measurement result:

$$Distance = c * \frac{Window 2 - Window 1}{Window 2 + Window 1} ,$$

wherein c is a constant (which can be pre-determined, specific for the ToF device, etc.), which can be derived in a calibration process, and wherein Window 1/2 refers to the respective determined distance in Window 1/2.

FIG. 2 depicts a further embodiment of a timing diagram 10 of a signaling for determining a distance to a scene.

In this embodiment, only Window 2 is depicted for simplicity and the embodiment is explained exemplarily only for Window 2, but the principle can also be applied to Window 1.

Window 2 is split into a Window 2a and a Window 2b.

In Window 2a, four modulation pulses 13 are generated in the precise imaging mode. An envelope of the modulation pulses 13 corresponds to a modulation pulse of the coarse imaging mode.

In Window 2a, four modulation pulses 11 and four modulation pulses 11′ are generated in the precise imaging mode and a respective envelope of the four modulation pulses 11 and the four modulation pulses 11′ corresponds to a modulation pulse of the precise imaging mode.

Thereby, in Window 2a and in Window 2b, the coarse imaging mode and the precise imaging mode are superposed and, thus, generate a superposed imaging mode, as it is also discussed above.

With the superposed imaging mode, a coarse depth information is generated by detecting a respective envelope of illumination pulses 12 and 12′ with the envelopes of the modulation pulses 11, 11′ and 13, and precise depth information is generated by detecting the illumination pulses 12 and 12′ with the modulation pulses 11, 11′ and 13.

The coarse depth information is used to determine a starting position POS in Window 2a.

If the starting position cannot be determined within one measurement (or a measurement error is above a predetermined threshold or exceeds a measurement range), a random starting position is provided (also several times) in order to decrease the measurement error.

In the embodiment of FIG. 2, a moving scene and/or a moving ToF imaging apparatus does not result in a deteriorated distance determination, since there is (almost) no delay between the coarse imaging mode and the precise imaging mode.

Furthermore, in this embodiment, the coarse depth data of obtained in the coarse imaging mode in Window 2a and the precise depth data obtained in the precise imaging mode in Window 2b are stored on different storage nodes in order to determine a starting position while determining the distance at roughly the same time.

Window 1 of FIG. 1 may be split in a similar way as it is described with reference to FIG. 2

Window 1a, 1b, 2a and 2b, in such embodiments, correspond to four phases as they are generally known for phase ToF and, thus, the read-out of the Windows 1a, 1b, 2a and 2b is processed in order to obtain phase information and, therefore, reconstruct a distance or a depth image.

For example, combining Window 1a and Window 2a may result in the phase 0 degrees (also referred to as M0), combining Window 1b and 2b may result in 180 degrees (M180), combining Window 1a and 2b may result in 90 degrees (M90), and combining Window 1b and 2a may result in 270 degrees (M270).

Thus, the distance may be calculated according to the following formula:

$$Distance = k * \frac{M 0 - M 180}{( M 90 - M 270 ) + ( M 0 - M 180 )} ,$$

wherein k is a constant (which can be (pre-)determined, specific for the ToF device, etc.), which may be determined with a calibration procedure, and the like.

Such a measurement may be performed four times (for each phase) and the confidence corresponds to the sum of the respective measurements.

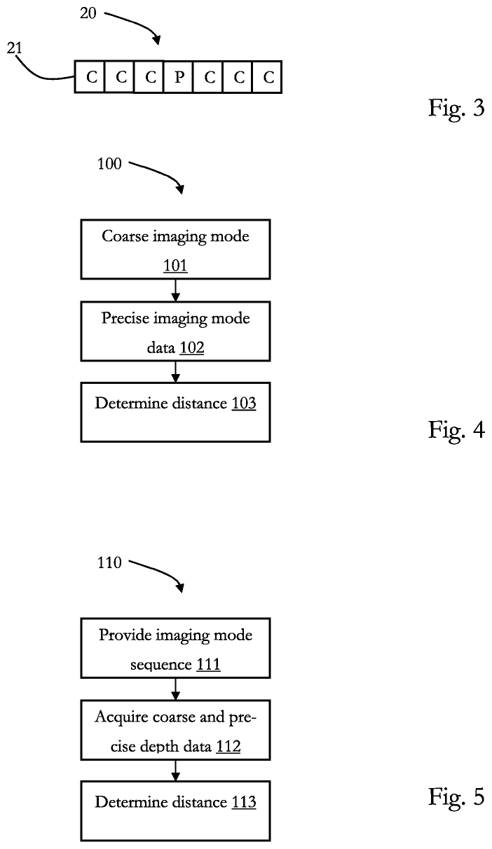

FIG. 3 depicts a block diagram of an imaging mode sequence 20.

The imaging mode sequence 20 is provided by circuitry included in a ToF imaging apparatus, as described herein.

In this embodiment, the imaging mode sequence 20 is predetermined (pre-programmed) and includes a succession of imaging frames 21. The imaging frames include coarse imaging frames C in the coarse imaging mode, and precise imaging frames P in the precise imaging mode.

The imaging mode sequence 20 includes three coarse imaging frames C, followed by a precise imaging frame P, followed by three coarse imaging frames C.

It should be noted that the imaging mode sequence is not limiting. The number of frames may be any number (above one), and a type of frames (C or P) may also be any number equal to or above zero, and an ordering (i.e. the specific imaging mode sequence) may be any permutation of the imaging modes.

FIG. 4 depicts a block diagram of a method 100 according to the present disclosure.

In 101, coarse depth data is acquired in the coarse imaging mode.

In 102, precise depth data is acquired in the precise imaging mode.

In 103, a distance to a scene is determined, as it is described herein.

FIG. 5 depicts a block diagram of a method 110 according to the present disclosure.

In 111, an imaging mode sequence is provided. In this embodiment, the imaging mode sequence is predetermined. It may, however, be random, or depending on external or internal conditions, a power requirement, an intensity requirement, a contrast requirement, an aliasing distance, a measurement range, a motion of the ToF imaging apparatus, a preceding imaging mode, and the like, as discussed herein.

In 112, coarse and/or precise depth data are acquired according to the present disclosure.

In 113, a distance is determined, as discussed herein.

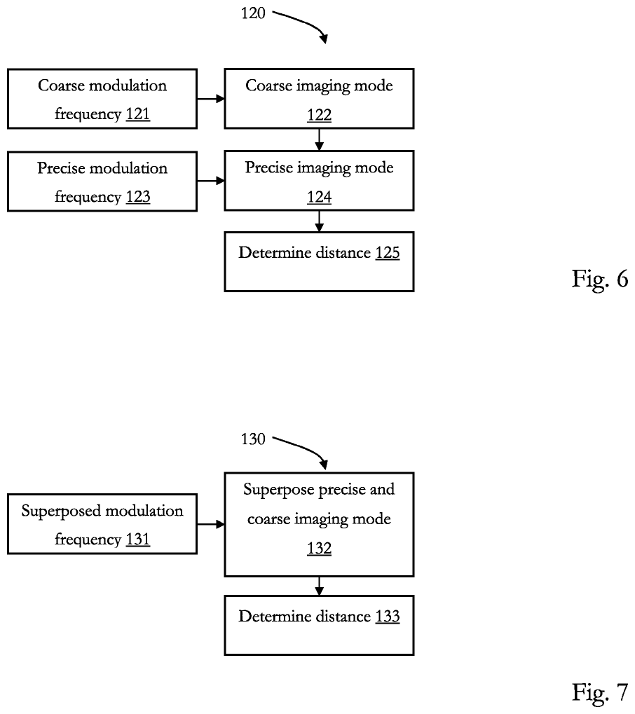

FIG. 6 depicts a block diagram of a method 120 according to the present disclosure.

In 121, a coarse modulation frequency is applied to a transfer gate of a ToF imaging apparatus, as described herein.

Thereby, in 122, the coarse imaging mode is applied.

In 123, a precise modulation frequency is applied to the transfer gate of the ToF imaging apparatus.

Thereby, in 124, the precise imaging mode is applied.

In 125, a distance to a scene is determined.

FIG. 7 depicts a block diagram of a method 130 according to the present disclosure.

In 131, a superposed modulation frequency is applied to a transfer gate of a ToF imaging apparatus.

Thereby, in 132, the precise and the coarse imaging mode are superposed, as well.

From the acquired data, i.e. coarse depth data and precise depth data, acquired in 132, a distance is determined, in 133.

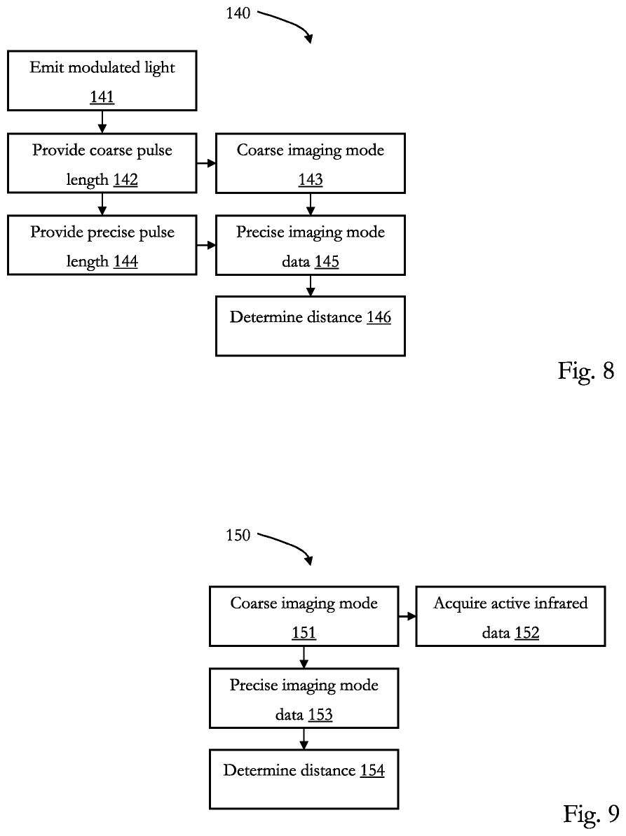

FIG. 8 depicts a block diagram of a method 140 according to the present disclosure.

In 141, modulated light is emitted, e.g. by a pulsed light source, as discussed herein.

The emitted modulated light has a coarse pulse length, in 142.

In 143, in response to the emission of the modulated light with the coarse pulse length, the coarse depth data is acquired in the coarse imaging mode.

In 144, the emitted modulated light is provided to have a precise pulse length.

In 145, in response to the emission of the modulated light with the precise pulse length, the precise depth data is acquired in the precise imaging mode.

In 146, a distance is determined from the coarse depth data and the precise depth data, as discussed herein.

FIG. 9 is a block diagram of a method 150 according to the present disclosure.

In 151, the coarse imaging mode is applied.

However, in 152, active infrared data (as it is described above) is acquired in the coarse imaging mode.

In 153, the precise imaging mode is applied.

In 154, a distance is determined based on the precise depth data acquired in the precise imaging mode.

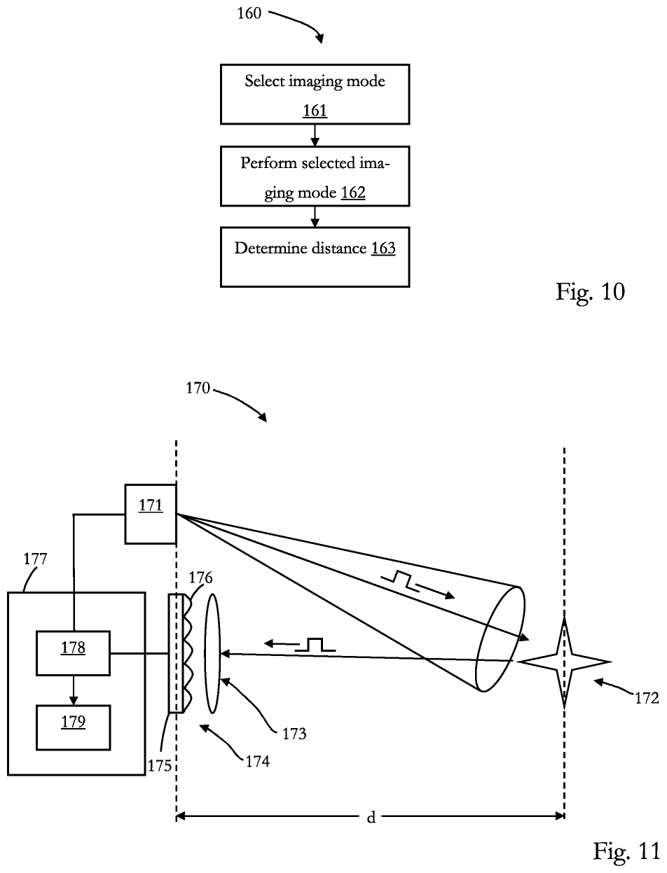

FIG. 10 depicts a block diagram of a method 160 according to the present disclosure.

In 161, an imaging mode is selected, according to requirements, as discussed herein. As discussed above, also an imaging mode sequence may be selected according to such requirements.

In 162, the selected imaging mode (or imaging mode sequence) is applied.

In 163, a distance is determined based on the data acquired in 162.

It should be noted that the methods, which are described with reference to FIGS. 4 to 10, may also be combined. For example, in the imaging mode sequence as described with reference to FIG. 5 (or the selected imaging mode of FIG. 10), respective modulation frequencies may be applied (described in FIG. 6) to transfer gates and/or modulated light (described in FIG. 8) may be provided accordingly.

Moreover, a combination of the methods may be envisaged, if active infrared data is acquired in the coarse imaging mode.

Referring to FIG. 11, there is illustrated an embodiment of a time-of-flight (ToF) imaging apparatus 170, which can be used for depth sensing or providing a distance measurement, in particular for the technology as discussed herein, wherein the ToF imaging apparatus 170 is configured as an iToF camera. The ToF imaging apparatus 170 has circuitry 177, which is configured to perform the methods as discussed herein and which forms a control of the ToF imaging apparatus 170 (and it includes, not shown, corresponding processors, memory and storage, as it is generally known to the skilled person).

The ToF imaging apparatus 170 has a pulsed (modulated) light source 171 and it includes light emitting elements (based on laser diodes), wherein in the present embodiment, the light emitting elements are narrow band laser elements.

The light source 171 emits light, i.e. modulated light, as discussed herein, to a scene 172 (region of interest or object), which reflects the light. The reflected light is focused by an optical stack 173 to a light detector 174.

The light detector 174 has a time-of-flight imaging portion, as discussed herein, which is implemented based on multiple CAPDs formed in an array of pixels and a micro lens array 176 which focuses the light reflected from the scene 172 to the time-of-flight imaging portion 175 (to each pixel of the image sensor 175).

The light emission time and modulation information is fed to the circuitry or control 177 including a time-of-flight measurement unit 178, which also receives respective information from the time-of-flight imaging portion 175, when the light is detected which is reflected from the scene 172. On the basis of the modulated light received from the light source 171 and the coarse depth data and/or the precise depth data acquired in the coarse and/or precise imaging mode, the time-of-flight measurement unit 178 computes a phase shift of the received modulated light which has been emitted from the light source 171 and reflected by the scene 172 and on the basis thereon it computes a distance d (depth information) between the image sensor 175 and the scene 172.

The depth information is fed from the time-of-flight measurement unit 178 to a 3D image reconstruction unit 179 of the circuitry 177, which reconstructs (generates) a 3D image of the scene 172 based on the depth information received from the time-of-flight measurement unit 178.

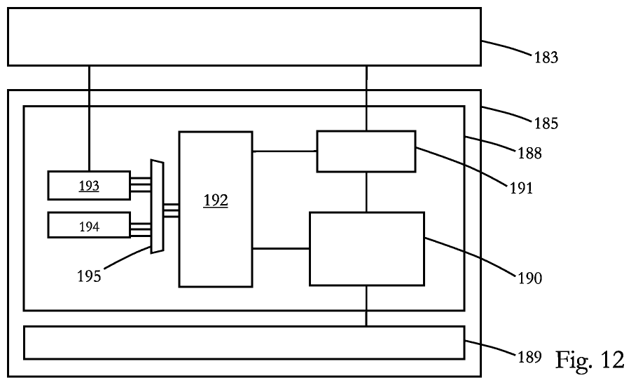

FIG. 12 illustrates an embodiment of the ToF imaging apparatus 185 in a block diagram in more detail.

The ToF imaging apparatus 185 shows, exemplarily, how a control according to the present disclosure, i.e. the providing of the coarse imaging mode and the precise imaging mode, can be provided in some embodiments.

However, the present disclosure is not limited to the embodiment shown in FIG. 12, since the coarse imaging mode and the precise imaging mode may be provided with known methods, as well.

The ToF sensor 185 has logic circuitry 188 and a light sensing circuitry 189 including an array of light detection pixels, analog-to-digital conversion, etc., such that the light sensing circuitry 189 can output light sensing signals to the logic circuitry 188 in response to detected light.

The log circuitry 188 has a processor/control unit 190, a data interface 191, a register circuitry 192, a bus controller 193 (which is a I²C slave controller), a sequencer circuitry 194 and a multiplexer 195.

The control unit 190 is connected to the light sensing circuitry 189 and receives the light sensing signals from it, which are digitized by analog-to-digital conversion performed by the light sensing circuitry 189, and passes the digitized light sensing signals to the register circuitry 192, to which it is connected, for intermediate storage.

The control unit 190 is also connected to the data interface 191, which, in turn, is connected to a processing unit of a host circuitry 183, such that the processing unit of the host circuitry 183 and the control unit 190 of the ToF sensor 185 can communicate over the data interface 191 with each other.

On the other hand, the bus controller 193 is connected over an I²C bus with a configuration unit of the host circuitry, and it is connected to the register circuitry 192 and to the sequencer circuitry 194 over the multiplexer 195.

Hence, the configuration unit of the host circuitry 183 can transmit control or configuration data/commands over the I²C bus and the bus controller 193 to the sequencer circuitry 194 for controlling and/or configuring the sequencer circuitry 194. For instance, the configuration unit can also transmit sequence configurations as discussed herein to the sequencer circuitry 194.

The control unit 190 is configured to generate data frames within the coarse and/or the precise imaging mode, as discussed herein, on the basis of the settings of the registers of the register circuitry 192, which in turn is set by the sequencer circuitry 194, e.g. based on sequence configurations received from the configuration unit of the host circuitry 183.

In this embodiment, the ToF system is real-time configurable, since the sequencer circuitry 194 is able to change the type of frame from one frame to another by changing the associated register setting, such that, for example, during operation first type and second type frames can be generated.

It should be noted that the embodiments of the ToF imaging apparatuses 170 and 185 may also be combined, i.e. the techniques described with reference to FIG. 12 (ToF imaging apparatus 185) may be implemented in the ToF imaging apparatus 170 of FIG. 11.

It should be recognized that the embodiments describe methods with an exemplary ordering of method steps. The specific ordering of method steps is however given for illustrative purposes only and should not be construed as binding. For example the ordering of 101 and 102 in the embodiment of FIG. 4 may be exchanged. Also, the ordering of 151, 152 and 153 in the embodiment of FIG. 9 may be exchanged. Further, also the ordering of 142 to 145 in the embodiment of FIG. 8 may be exchanged. Other changes of the ordering of method steps may be apparent to the skilled person.

Please note that the division of the control 177 into units 178 to 179 is only made for illustration purposes and that the present disclosure is not limited to any specific division of functions in specific units. For instance, the control 177 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight imaging apparatus comprising circuitry, configured to:
to acquire, in a coarse imaging mode, coarse depth data;
acquire, in a precise imaging mode, precise depth data; and
determine a distance to a scene based on the coarse depth data and the precise depth data.

(2) The time-of-flight imaging apparatus according to (1), wherein the circuitry is further configured to provide an imaging mode sequence including the coarse imaging mode and the precise imaging mode.

(3) The time-of-flight imaging apparatus according to (2), wherein the imaging mode sequence is at least one of a random sequence and a predetermined sequence.

(4) The time-of-flight imaging apparatus according to anyone of (1) to (3), further comprising an image sensor including at least one transfer gate, the circuitry being further configured to modulate, with a modulation signal, the at least one transfer gate for acquiring at least one of the coarse depth data and the precise depth data.

(5) The time-of-flight imaging apparatus according to (4), wherein the modulation signal includes, in the coarse imaging mode, a coarse modulation signal having a coarse modulation frequency and, in the precise imaging mode, a precise modulation signal having a precise modulation frequency, wherein the coarse modulation frequency and the precise modulation frequency differ from each other.

(6) The time-of-flight imaging apparatus according to (5), wherein the modulation signal includes a superposed modulation signal based on a superposing of the coarse modulation frequency and the precise modulation frequency, thereby superposing the coarse imaging mode and the precise imaging mode.

(7) The time-of-flight imaging apparatus according to anyone of (1) to (6), further comprising a pulsed light source configured to emit modulated light for illuminating a scene, the circuitry being further configured to:
control the pulsed light source to provide a coarse pulse length in the coarse imaging mode; and
control the pulsed light source to provide a precise pulse length in the precise imaging mode, wherein the precise pulse length differs from the coarse pulse length.

(8) The time-of-flight imaging apparatus according to anyone of (1) to (7), wherein the circuitry is further configured to acquire, in the coarse imaging mode, active infrared data.

(9) The time-of-flight imaging apparatus according to anyone of (1) to (8), wherein the circuitry is further configured to select between one of the coarse imaging mode and the precise imaging mode.

(10) The time-of-flight imaging apparatus according to (9), wherein the selection is based on at least one of a power requirement of an imaging sensor, a power requirement of a light source, an intensity requirement of the light source, a contrast requirement, an aliasing distance, a measurement range, a motion of the time-of-flight imaging apparatus, and a preceding imaging mode.

(11) A time-of-flight imaging method, comprising:
acquiring, in a coarse imaging mode, coarse depth data;
acquiring, in a precise imaging mode, precise depth data; and
determining a distance to a scene based on the coarse depth data and the precise depth data.

(12) The time-of-flight imaging method according to (11), further comprising: providing an imaging mode sequence including the coarse imaging mode and the precise imaging mode.

(13) The time-of-flight imaging method according to (12), wherein the imaging mode sequence is at least one of a random sequence and a predetermined sequence.

(14) The time-of-flight imaging method according to anyone of (11) to (13), further comprising:
modulating, with a modulation signal, at least one transfer gate of an image sensor for acquiring at least one of the coarse depth data and the precise depth data.

(15) The time-of-flight imaging method according to (14), wherein the modulation signal includes, in the coarse imaging mode, a coarse modulation signal having a coarse modulation frequency and, in the precise imaging mode, a precise modulation signal having a precise modulation frequency, wherein the coarse modulation frequency and the precise modulation frequency differ from each other.

(16) The time-of-flight imaging method according to (15), wherein the modulation signal includes a superposed modulation signals based on a superposing of the coarse modulation frequency and the precise modulation frequency, thereby superposing the coarse imaging mode and the precise imaging mode.

(17) The time-of-flight imaging method according to anyone of (11) to (16), further comprising:
emitting modulated light for illuminating a scene with a pulsed light source;
controlling the pulsed light source to provide a coarse pulse length in the coarse imaging mode;
controlling the pulsed light source to provide a precise pulse length in the precise imaging to mode, wherein the precise pulse length differs from the coarse pulse length.

(18) The time-of-flight imaging method according to anyone of (11) to (17), further comprising: acquiring, in the coarse imaging mode, active infrared data.

(19) The time-of-flight imaging method according to anyone of (11) to (18), further comprising: selecting between one of the coarse imaging mode and the precise imaging mode.

(20) The time-of-flight imaging method according to (19), wherein the selection is based on at least one of a power requirement of an imaging sensor, a power requirement of a light source, an intensity requirement of the light source, a contrast requirement, an aliasing distance, a measurement range, a motion of a time-of-flight imaging apparatus, and a preceding imaging mode.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. A time-of-flight imaging apparatus comprising circuitry, configured to:
acquire, in a coarse imaging mode, coarse depth data;
acquire, in a precise imaging mode, precise depth data; and
determine a distance to a scene based on the coarse depth data and the precise depth data.

2. The time-of-flight imaging apparatus according to claim 1, wherein the circuitry is further configured to provide an imaging mode sequence including the coarse imaging mode and the precise imaging mode.

3. The time-of-flight imaging apparatus according to claim 2, wherein the imaging mode sequence is at least one of a random sequence and a predetermined sequence.

4. The time-of-flight imaging apparatus according to claim 1, further comprising an image sensor including at least one transfer gate, the circuitry being further configured to modulate, with a modulation signal, the at least one transfer gate for acquiring at least one of the coarse depth data and the precise depth data.

5. The time-of-flight imaging apparatus according to claim 4, wherein the modulation signal includes, in the coarse imaging mode, a coarse modulation signal having a coarse modulation frequency and, in the precise imaging mode, a precise modulation signal having a precise modulation frequency, wherein the coarse modulation frequency and the precise modulation frequency differ from each other.

6. The time-of-flight imaging apparatus according to claim 5, wherein the modulation signal includes a superposed modulation signal based on a superposing of the coarse modulation frequency and the precise modulation frequency, thereby superposing the coarse imaging mode and the precise imaging mode.

7. The time-of-flight imaging apparatus according to claim 1, further comprising a pulsed light source configured to emit modulated light for illuminating a scene, the circuitry being further configured to:
control the pulsed light source to provide a coarse pulse length in the coarse imaging mode; and
control the pulsed light source to provide a precise pulse length in the precise imaging mode, wherein the precise pulse length differs from the coarse pulse length.

8. The time-of-flight imaging apparatus according to claim 1, wherein the circuitry is further configured to acquire, in the coarse imaging mode, active infrared data.

9. The time-of-flight imaging apparatus according to claim 1, wherein the circuitry is further configured to select between one of the coarse imaging mode and the precise imaging mode.

10. The time-of-flight imaging apparatus according to claim 9, wherein the selection is based on at least one of a power requirement of an imaging sensor, a power requirement of a light source, an intensity requirement of the light source, a contrast requirement, an aliasing distance, a measurement range, a motion of the time-of-flight imaging apparatus, and a preceding imaging mode.

11. A time-of-flight imaging method, comprising:
acquiring, in a coarse imaging mode, coarse depth data;
acquiring, in a precise imaging mode, precise depth data; and
determining a distance to a scene based on the coarse depth data and the precise depth data.

12. The time-of-flight imaging method according to claim 11, further comprising: providing an imaging mode sequence including the coarse imaging mode and the precise imaging mode.

13. The time-of-flight imaging method according to claim 12, wherein the imaging mode sequence is at least one of a random sequence and a predetermined sequence.

14. The time-of-flight imaging method according to claim 11, further comprising:
modulating, with a modulation signal, at least one transfer gate of an image sensor for acquiring at least one of the coarse depth data and the precise depth data.

15. The time-of-flight imaging method according to claim 14, wherein the modulation signal includes, in the coarse imaging mode, a coarse modulation signal having a coarse modulation frequency and, in the precise imaging mode, a precise modulation signal having a precise modulation frequency, wherein the coarse modulation frequency and the precise modulation frequency differ from each other.

16. The time-of-flight imaging method according to claim 15, wherein the modulation signal includes a superposed modulation signals based on a superposing of the coarse modulation frequency and the precise modulation frequency, thereby superposing the coarse imaging mode and the precise imaging mode.

17. The time-of-flight imaging method according to claim 11, further comprising:
emitting modulated light for illuminating a scene with a pulsed light source;
controlling the pulsed light source to provide a coarse pulse length in the coarse imaging mode;
controlling the pulsed light source to provide a precise pulse length in the precise imaging mode, wherein the precise pulse length differs from the coarse pulse length.

18. The time-of-flight imaging method according to claim 11, further comprising: acquiring, in the coarse imaging mode, active infrared data.

19. The time-of-flight imaging method according to claim 11, further comprising: selecting between one of the coarse imaging mode and the precise imaging mode.

20. The time-of-flight imaging method according to claim 19, wherein the selection is based on at least one of a power requirement of an imaging sensor, a power requirement of a light source, an intensity requirement of the light source, a contrast requirement, an aliasing distance, a measurement range, a motion of a time-of-flight imaging apparatus, and a preceding imaging mode.
